(19) United States
(12) Patent Application Publication
(10) Pub. No.: US 2025/0064095 A1
(43) Pub. Date: Feb. 27, 2025

(54) EDIBLE MYCELIATED COMPOSITION

(71) Applicant: INNOMY BIOTECH, S.L, BILBAO (ES)

(72) Inventors: PABLO IGNACIO SANCHEZ REY, CIUDAD AUTÓNOMA DE BUENOS AIRES (AR); JUAN PABLO DE GIACOMI, BUENOS AIRES (AR); FERNANDO MORO CORDOBÉS, BILBAO (ES)

(21) Appl. No.: 18/724,338

(22) PCT Filed: Dec. 27, 2022
(86) PCT No.: PCT/EP2022/087855

§ 371 Date: Jun. 26, 2024

(30) Foreign Application Priority Data
Dec. 27, 2021 (EP) 21383225.6

(51) Int. Cl. A23L 7/104; A23J 3/16; A23J 3/22; A23L 31/00

(52) U.S. Cl. CPC A23L 7/104; A23J 3/16; A23J 3/227; A23L 31/00

(57) ABSTRACT

A multi-step process for the preparation of a protein myceliated composition, in which a particular substrate comprising cereals and legumes is colonized with the mycelia of a filamentous fungus. In the process solid fermentation of the substrate is carried out. The process provides a composition that resembles actual meat and that can be used as meat analogue.

This application claims the benefit of the European Patent Application 21383225.6 filed on 27 Dec. 2021.

The invention relates to the field of food and nutrition, in particular, to the provision of edible myceliated compositions based on plant material fermented by fungal strains featured as animal meat-textured products.

### BACKGROUND ART

Due to the increasing demand of protein due to the growth of world population, one of the trending challenges is to reduce the impact on the climate change associated with the obtention of most of the proteins of animal origin from livestock. It is widely known that farming contributes to global warming. It is also widely accepted and proved that vegetarian, vegan or “meat reduced” diets imply a lower impact on environment.

However, it is still challenging to create a plant-based product resembling actual meat. Plant-based meat is usually obtained by means of complex and expensive processes to achieve most of the features of meat (flavour, aroma, texture, colour, etc.), which are to be maintained as “meat-like” when the plant-based product is cooked as meat. As a result, plant-based products are low in protein, and their structure is artificially provided by polymeric polysaccharides or proteins, resulting more similar to a paste than to a cohesive structure or slightly elastic product as actual meat.

With the aim of overcoming these disadvantages of low protein contents, artificial structure and texture of actual meat, several firms started to produce meat analogues using filamentous fungi that growth in vegetable substrates. This meat analogues are in part inspired in the Tempeh obtained from soybeans that are let ferment after being inoculated with the fungus Rhizopus oligosporus. One example of this is the food product for human or animal consumption proposed by Mycotechnology, Inc. in the international patent application WO2020232347. The inventors of WO2020232347 disclose a method to prepare a high protein food product, comprising the steps of sterilizing a substrate comprising grain and plant protein concentrates or isolates, of at least 50% protein in dry weight, and inoculating the sterilized substrate with a filamentous fungal strain in solid state fermentation conditions; and then culturing the filamentous fungus and the sterilized substrate, in such a way that the hyphae colonize and form a mycelial network resulting in a high protein food product. This food product is, after cooking, (i) more cohesive than a non-myceliated control substrate after cooking, and/or (ii) has more spring than a non-myceliated control substrate after cooking, and/or (iii) has more juiciness than a non-myceliated control substrate after cooking; and additionally. In addition, the protein food product has increased desirable flavours and/or reduced undesirable aromas and/or flavours compared to a non-myceliated control substrate. The inventors show the solid fermentation of a substrate comprising pea protein concentrate and short grain brown rice with a liquid inoculum of Morchella esculenta. This inoculum was previously prepared by inoculating the fungus in a mixture of sugar cane and pea protein until the formation of balls of biomass was observed (e.g., see Example 3). The inoculated substrate containing pea protein and short grain brown rice were cultured in autoclave bags, until the mycelium had fully colonized the media and included balls/chunks of myceliated rice/pea protein. The so obtained protein product could be cooked and the final organoleptic properties resembled to the ground beef in its texture, as well as an umami, providing savoury taste with no typical pea protein aroma and very little pea or rice aroma.

However, as the same inventors declare, when the method was carried out with different species of fungi, such as Tremella fuciformis (Example 12 in WO2020232347), Pleurotus ostreatus (example 13 in WO2020232347) and Pleurotus eryngii (Example 14 in WO2020232347) undesirable results were obtained, in terms of flavour, aroma, and low cohesiveness, among others.

Thus, it is desirable to provide a new process that could successfully be carried out with several fungi, which would allow to provide a wide spectrum of meat-like structures while maintaining a good meat-like texture, flavour, and aroma.

Other developments in which fungi are used to obtain meat-analogues, relate to the fermentation in bioreactors of a vegetal substrate with an inoculum of fungi. Pellets of fungi in mycelial form are obtained which are then concentrated and dried. One example of this technology is disclosed in the international patent application WO2017181085 (Mycotechnology Inc.). The concentrated myceliated product has a high protein content and constitutes an edible product. In WO2017181085, Lentinula edodes was assayed exemplified with a substrate containing pea, rice, and soy.

However, the production using these bioreactors imply the disadvantage of the need of big premises and also makes difficult the maintenance of sterility conditions. This is a huge problem, since all the batch would need to be discarded if contamination with a microorganism other than the fungus takes place, in the first place to avoid threatening the health of consumers, but also due to the alteration of the properties of the final product.

Also, another known technology using filamentous fungi to obtain myceliated edible products is the one disclosed, for example, in the international patent application WO2020061502 (The Better Meat Company), where the mycelia as such growing in typical culture media are processed to obtain a meat-analogue. In this type of document, no fermentation of vegetable material is carried out, and any analogy with meat is the one provided by the particular “meaty appearance” of the fungus.

In some other technologies, like the one applied by Atlastfood Co. to obtain an analogue of bacon, the product is obtained using only mycelia of basidiomycetes. The process requires particular fermenters (bioreactors) that regulate the carbon dioxide flow and the oxygen in the atmosphere and the distribution of nutrients, and for this reason, the costs transferred to the final product are high.

Therefore, there is still a need of other processes to produce meat-analogues, which being environmentally sustainable and customizable, also allow the obtaining of final products with the desired properties.

### SUMMARY OF INVENTION

Inventors realised that by means of a solid fermentation of a substrate containing cereals and legumes with an inoculum of a filamentous fungi, the resulting processed substrate, which is a high-protein myceliated composition, complies with the texture and organoleptic features of an actual animal meat (i.e., a patty of animal meat like a hamburger, or ground meat). This is in particular obtained when the filamentous fungi are previously grown in a substrate also containing cereals and optionally legumes, said substrate being the source of protein and other immediate principles, which once colonized is grinded and suspended in an osmotically balanced solution.

As will be illustrated in the examples below, the texture, as well as the flavour and aroma of the edible myceliated composition corresponds to that of actual meat (meat-like texture and organoleptic properties).

This process implies the advantage of being simple and cost-effective, devoid of complex processing like the texturization, while it allows the provision of a meat analogue (i.e., vegetarian and vegan products) in an environmentally friendly mode.

Moreover, when the process is carried out in particularly developed containers for that purpose, the texture and actual meat form appearance is guaranteed and, the sterility of the process is assured in a reproducible and an easy mode. These containers allow the carrying out of the process in a modular mode. By modular, the inventors understand that the biomass in fermentation is not maintained in a single chamber, but is divided in individual compartments isolated from each other, and that those “single chambers” can be assembled depending on the desired amount of product. This modular mode permits the manufacturing of batches of the desired amount of protein myceliated composition (i.e., edible myceliated compositions). In addition, the modular mode that assures sterility during the process, avoids the high costs associated with the maintenance of big bioreactors. Even more, the modular mode also brings the possibility of mounting manufacturing centres where needed and in a reliable way. Working with modular containers implies the advantage of a low-cost production, and a high yield and conversion rate.

Thus, inventors propose, as a first aspect, a process for the preparation of an edible myceliated composition comprising the following steps:
(i) Preparing a sterilized liquified inoculum of a filamentous fungal culture (i.e., of a mycelium forming fungus) by:
(1) adding under sterile conditions to a sterilized cereal and optionally legume-containing substrate, said substrate comprising at least oat, an amount of the filamentous fungal culture, and let the mixture ferment until the substrate is colonized with hyphae forming a mycelium network to obtain a fermented substrate; and
(2) adding a sterilized isosmotic liquid to the fermented substrate in (1), and liquefying by mixing or agitating or homogenising, to obtain the sterilized liquified inoculum;
(ii) Preparing a sterilized fermentable substrate, said substrate comprising one or more cereals including oat and rice, and one or more legumes or a textured isolated protein of these legumes, by hydrating the substrate, disposing it in a container adapted to allow exchange of gases, and sterilizing the container with the substrate;
(iii) Inoculating in sterile conditions the sterilized fermentable substrate of step (ii) with the liquified inoculum of (i); and
(iv) Culturing the sterilized fermentable substrate with the liquified inoculum for a time to allow the growth of hyphae and formation of a mycelial network within the fermented substrate to obtain the myceliated composition, which is, an edible myceliated composition, in particular, a myceliated high protein food composition.

After this process, thus, a high-protein myceliated composition is obtained with the meat-like features in terms of high protein contents (from fungi, cereals and legumes) and in terms of organoleptic properties. Indeed, the final product exhibits an improved aminoacidic profile in its protein due to the transformation and incorporation of the plant nitrogen to the fungal protein pool, i.e., with a higher lysin content than the vegetal substrate prior to fermentation. In other words, the method can also be referred as a method for the preparation of a food product, namely a myceliated food product, which is a product with high protein contents.

The presence of the selected cereals in steps (i) and (ii), that is, in the fermentation steps of the process, surprisingly allowed the process to work with a broad spectrum of fungi giving good results. Therefore, it is proposed herewith a substrate for the fermentations that allows versatility. This versatility is of importance since certain fungi impart to the final myceliated composition certain flavours or aromas that are appreciated by the consumers. Indeed, if the selected cereals were not in the substrates of steps (i) and (ii), the results were not satisfactory mainly in terms of conversion rate of the cereal protein by the fungi and/or in terms of final texture and organoleptic parameters of the final edible myceliated composition.

Further, for the preparation of the inoculum, the strain is growing on a medium that is similar to the final substrate of the subsequent process step (ii) and this avoids the “lag phase” that an inoculum from a liquid medium would need.

Moreover, with this process the quality and amount of the components can be easily controlled (proteins, lipids, carbohydrates, etc.).

Thus, a second aspect of the invention is an edible myceliated composition (or synonymously, a myceliated food product) comprising mycelia of a filamentous fungus culture and a mixture of one or more fermented cereals and of one or more fermented legumes, obtainable by the process as defined in the first aspect, wherein the fermented substrate comprises oat. This composition comprises high amounts of protein (i.e., 9-23% w/w) from the substrate itself (cereal and legume protein) and from the mycelium, which also contains proteins.

When in this description high amounts of protein are indicated, it is in particular an amount from 9 to 23% by weight (w/w) in relation to the weight of the total edible myceliated composition. Particular amounts are thus selected from 9, 10, 11, 12, 13, 14, 15, 16, 17, 18, 19, 20, 21, 22, and 23% w/w.

As will be illustrated in the examples, the parameters of the compositions of the invention resemble those of a meat burger in terms of its texture. Thus, for example, the maximal force (in newtons) obtained by a texturometer (TA.XT2 Plus C with a mini-Kramer probe HDP/MK05) in Kramer assay, or the corresponding force-distance curves in this assay, revealed values for the compositions of the invention around 120-150 Newtons.

Moreover, in a sensorial test, including the flavour, taste, texture and appearance of the composition, all the edible myceliated compositions of the invention in the form of a patty, obtained very good values by the volunteers.

A third aspect of the invention relates to the use of a mentioned edible myceliated composition as defined in the first aspect as a meat analogue.

Finally, a fourth aspect of the invention is a meat analogue comprising or consisting of an edible myceliated composition as defined in the first aspect. This fourth aspect encompasses, thus, derivate or complex or composite products that among their ingredients include the protein myceliated composition as defined in the first aspect.

### BRIEF DESCRIPTION OF DRAWINGS

FIG. 1, related with Example 2, shows a picture of a cooked edible myceliated composition (patty) of the invention.

FIG. 2, related with Example 2, shows the maximal force in Newtons (max.F (N)) in a Kramer assay for the texture of the compositions of the invention (PC1, PC2 and PC3). Veg relates to a non-myceliated plant-based patty comparative example and Meat relates to a meat patty (meat burger).

FIG. 3 shows the force-distance curves derived from Kramer assay of the meat burger (a) and the compositions PC1 (b), PC2 (c) and PC3 (d) of FIG. 2.

FIG. 4, related with Example 2, is a radar plot showing the score and the interconnections of sensorial parameters for each of edible compositions of the invention comprising mycelia of two P. ostreatus strains (HK 35 (Sylvan, USA), 3253 (Sylvan, USA).

FIG. 5, related with Example 3, illustrates the maximal force in Newtons (max.F (N)) in a Kramer assay for the texture of the compositions of the invention obtained with two strains of Pleurotus. Veg relates to a plant-base patty comparative example and Meat relates to a meat patty (meat burger).

FIG. 6 is a Pareto chart showing the individual standardized effect of each of the components of the substrate mixture (oat (A), barley (B), soy protein (C), rapeseed (D), chickpea (E), maize (F), millet (G), beans (H), pea (I), rye (J), sunflower seed (K) and rice (L) on the growth of P. ostreatus (significance level α=0.05). The discontinued line shows the significance level.

FIG. 7 shows the principal component analysis PCA, A: Score plot showing how the different samples analysed are distributed in the first two principal components. VH: Vegan hamburger; MH: Meat hamburger; O: Oat hamburger; WO: Without oat hamburger. B: Influence plot showing which variables have the greatest effect on each component. 1: Hardness; 2: Gumminess; 3: Chewiness; 4: Adhesiveness; 5: Resilience; 6: Sponginess; 7: Cohesiveness.

### DETAILED DESCRIPTION OF THE INVENTION

All terms as used herein in this application, unless otherwise stated, shall be understood in their ordinary meaning as known in the art. Other more specific definitions for certain terms as used in the present application are as set forth below and are intended to apply uniformly through-out the specification and claims unless an otherwise expressly set out definition provides a broader definition.

As used herein, the indefinite articles “a” and “an” are synonymous with “at least one” or “one or more.” Unless indicated otherwise, definite articles used herein, such as “the” also include the plural of the noun.

The term “myceliated” encompasses a composition comprising mycelia developed by a fungus in its vegetative state. In most fungi, hyphae, a long, branching filamentous structure (hypha) are the main mode of vegetative growth. Hyphae are collectively called a mycelium. Mycelium is mainly composed of natural polymers as chitin, cellulose, proteins, etc, so it is a natural polymeric composite fibrous material. The term “non-myceliated” refers to composition or product which does not comprise mycelia.

The term “filamentous fungal culture” also referred to as “mycelium forming fungus” refers to any fungal culture that grows in filaments, i.e., hyphae or mycelia.

The expression “edible” is to be understood as the property of materials, compositions or vehicles (solvents) that can be ingested (food grade) and that are compatible with other ingredients in a product for food consumption. It must be for humans and animals use without excessive toxicity, irritation, allergic response, immunogenicity or other problems or complications commensurate with a reasonable benefit/risk ratio.

The term “solid fermentation” as used herein refers to a fermentation in solid state that uses culture substrates, particularly hydrated solid culture substrates, that do not allow the free movement or flotation of the microorganisms.

The term, “cereal” as used herein refers to the fruits from a plant of the monocotyledonous family Poaceae. Non-limiting examples of cereals include oat, rice, wheat, corn (maize), barley, millet, rye, spelt, sorghum, and the like.

The term “legume” refers to the fruit or seed of leguminous plants from the family Fabaceae. Non-limiting examples include soy, cheek bean, bean, vetch, alfalfa, clover, chickpea, green pea, yellow pea, black eyed peas, and the like.

The expression “textured isolated protein”, also known as “textured vegetable protein” (used as synonym in this description) relates to a defatted by-product of extracted cereals or legumes. It comprises high contents of proteins (more than 50% by weight) and results from the extrusion into various shapes (chunks, flakes, nuggets, grains, and strips) through a nozzle. The most known textured isolated protein is the textured soy protein (TSP), soy meat, or soya chunks, which is widely used as a meat analogue or meat extender. Texture isolated proteins are commercially available.

The term “cereal and optionally legume-containing substrate” refers to a substrate comprising one or more cereals, and optionally one or more legumes as defined herein.

The term “meat analogue” is a food industry term for a meat-like substance made from plant ingredients. Other common terms to define a meat analogue are plant-based meat, vegan meat, meat substitute, mock meat, meat alternative, imitation meat, or vegetarian meat.

The term “isosmotic” composition refers to a composition having the osmolality of a fungal cell's content.

The terms “culturing”, “incubating” or “fermenting” are used herein interchangeably to refer to the process of cultivating a filamentous fungal culture with a substrate by letting the fungus reproduce (i.e., grow) and colonize the substrate, in particular by forming a mycelium network within and around the external substrate volume. The term “fermentable substrate” refers to a substrate that can be metabolically broken down by the extracellular enzymes of the mycelium under appropriate conditions. The term “fermented substrate”, also referred to as “cultured substrate” refers to a substrate that has been produced by a process comprising culturing it with a filamentous fungal culture or an inoculum thereof, such that a mycelium network is formed within and around the external substrate volume.

The term “liquefying” refers to the transformation of a substantially solid material into a substantially liquid material. The term “liquified” means substantially in liquid form.

The terms “sterile or sterilized” are used herein interchangeably and refer to a composition or condition in which undesired microbial and/or fungal contamination is absent. For the purposes of the present invention, undesired viable microorganisms refer to microorganisms other than the filamentous fungal culture or inoculum thereof which is used in the fermentation steps i) and ii).

The terms “mixing”, “agitating” or “homogenizing” are used interchangeably and relate to the disruption of the solid phase by grinding and dispersing it within a liquid phase thus achieving a fluid homogeneous mixture.

The term “lag phase” as used herein refers to the time needed for the microorganism to adapt to a new substrate and one of the determining factors is the “culture history” (the differences between the origin and the goal media).

The term “hardness” as used herein refers to the peak force that occurs during the first compression. The term “resilience” as used herein refers to the quotient of the upstroke energy of the first compression by the downstroke energy of the first compression. The term “gumminess” as used herein refers to the necessary force to disintegrate the sample.

The term “chewiness” as used herein refers to the necessary penetration force by a sounding device simulating teeth. The term “adhesiveness” as used herein refers to the force needed to withdraw the attraction forces between the surface of the sample and the surface of the materials in contact with it. The term “cohesiveness” as used herein refers to how well the product withstands a second deformation relative to its resistance under the first deformation. The term “sponginess” as used herein refers to the capacity of recovering the initial shape after compression due to cavities or bubbles.

As previously indicated, in a first aspect, the invention relates to a process for the preparation of an edible myceliated composition comprising the following steps:
(i) Preparing a sterilized liquified inoculum of a filamentous fungal culture by: (1) adding under sterile conditions to a sterilized cereal and optionally legume-containing substrate, said substrate comprising at least oat, an amount of the filamentous fungal culture, and let the mixture ferment until the substrate is colonized with hyphae and mycelium network, to obtain a fermented substrate; and (2) adding a sterile isosmotic liquid composition to the fermented substrate in (1) and liquefying by mixing (or homogenizing), to obtain the sterilized liquified inoculum;
(ii) Preparing a sterilized fermentable substrate, said substrate comprising one or more cereals including oat and rice, and one or more legumes or a textured isolated protein thereof, by hydrating the substrate and disposing it in a container (i.e., recipient) adapted to allow gas exchange, and sterilizing the containers with the substrate inside;
(iii) Inoculating in sterile conditions the sterilized fermentable substrate of step (ii) with the liquified inoculum of (i); and
(iv) Incubating the sterilized fermentable substrate with the liquified inoculum for a time to allow the growth of hyphae and formation of a mycelial network within the fermented substrate to obtain the protein myceliated composition.

When in this description it is indicated that the substrates to be fermented comprise cereals or cereals and legumes, it is to be understood that any part of the cereals and of legumes are used. For example, there can be used the seeds, grains, leaves, stems, shoots, rootlets of rice, oat, corn, etc., but the substrate can contain particularly prepared and commercially available protein extracts of these cereals or legumes. In any of the cases, the substrate is defined as comprising cereals or cereals and legumes, when applicable.

In a particular embodiment, the sterilized fermentable substrates used in steps (i) and (ii) comprise said substrate in form of grains of the used cereals and/or legumes. In an alternative embodiment, the substrates of steps (i) and (ii) are milled, thus in form of flour. In another particular embodiment a mixture of substrates (cereals and/or legumes) are in form of a mixture of grains and flours.

These substrates, independently of their nature (cereals or mixture of cereals and legumes) are sterilized, for example by autoclaving. In the alternative, other physical means e.g., gamma radiation can be used.

In a particular embodiment, sterilization is carried out at a temperature from 100° C. to 130° C. for a period for 20 to 40 minutes. This particular sterilization schedule is preferably applied to the sterilized fermentable substrate in the containers permeable to gases (i.e., the containers that allow the exchange of gases). In a most particular embodiment, the temperature is selected from 100° C. to 125° C. more in particular it is selected from 120° C. to 125° C., even more in particular from 120, 121, 122, 123, 124 and 125° C. In another particular embodiment, optionally in combination with the embodiments of the process above or below, the time of sterilization of the fermentable substrate in the container permeable to gases of step (ii) is selected from 20, 25, 30, 35, and 40 minutes. This way, with a fast and easy mode all the materials are prepared prior to the inoculation.

In one particular embodiment of the process, the filamentous fungal culture used in step 1) comprises one or more lignocellulolytic fungi, more particularly the filamentous fungal culture comprises one or more fungi selected from the group consisting of ascomycetes, basidiomycetes (including agaricomycetes), and mixtures thereof.

In another particular embodiment of the process, the filamentous fungal culture used in step 1) comprises one or more fungi selected from the group consisting of Pleurotus, Ganoderma, Lentinula, and combinations thereof. More particularly, the filamentous fungal culture used in step 1) comprises one or more fungi selected from the group consisting of Pleurotus ostreatus, Pleurotus djamor, Lentinula edodes, Ganoderma Ganoderma applanatum, Ganoderma lucidum, Ganoderma resinaceum, and combinations thereof.

Even more particularly, the filamentous fungal culture used in step 1) comprises one or more fungi selected from the group consisting of Pleurotus ostreatus strain HK 35 (Sylvan, USA), Pleurotus ostreatus strain 3253 (Sylvan, USA), Pleurotus ostreatus strain 3115 (Sylvan, USA), Pleurotus ostreatus strain 3009 (Sylvan, USA), Pleurotus ostreatus strain M2175 (Mycelia, Belgium), Pleurotus ostreatus strain 3015 (Amycel, the Netherlands), Lentinula edodes strain M3790 (Mycelia, Belgium), Lentinula edodes strain M3770 (Mycelia, Belgium), Lentinula edodes strain M3102 (Mycelia, Belgium), Lentinula edodes strain 4082 (Amycel, The Netherlands), Pleurotus djamor strain M2708 (Mycelia, Belgium), Ganoderma applanatum strain M9710 (Mycelia, Belgium), Ganoderma lucidum strain M9720 (Mycelia, Belgium), Ganoderma lucidum strain M9726 (Mycelia, Belgium), Ganoderma resinaceum strain M9732 (Mycelia, Belgium), and combinations thereof.

In another particular embodiment of the process, the filamentous fungal culture used in step 1) further comprises a culture medium which comprises an agar mat extract medium (MEA) comprising malt extract, glucose and agar, or other media such as Glucose Potato Agar (GPA), Yeast extract, peptone, glucose agar (YPGA).

In another particular embodiment of the process, the sterilized cereal and optionally legume-containing substrate consists of oat, more particularly oat grains. More particularly, the grains have a particle size from 1 to 5 mm. Grains are typically obtained by milling and sieving.

In another particular embodiment of the process, the sterilized cereal and optionally legume-containing substrate comprises oat and rice, more particularly oat and rice grains. More particularly, the grains have a particle size from 1 to 5 mm.

In another particular embodiment of the process, the sterilized cereal and optionally legume-containing substrate further comprises other grains such as fruits from plants of the Brassicaceae or the Chenopodiaceae family, such as for example quinoa and rape grain. More particularly, the other grains have a particle size from 1 to 5 mm.

In another particular embodiment of the process, for the preparation of the inoculum of step 1), the sterilized cereal and optionally legume-containing substrate, said substrate comprising at least oat, is previously hydrated. In a more particular embodiment, hydrating is carried out by the addition of an aqueous composition, such a water or salted water, at either room temperature (i.e., 18-28° C.) or while raising the temperature of said water or aqueous composition from 70° C. to 100° C. In the particular case when temperature is raised, the substrate is hydrated by boiling it for a period of time. Particular hydrating or boiling times are from 4 to 15 minutes, in particular selected from 4, 5, 6, 7, 8, 9 and 10 minutes. Different cereals and/or legumes in the substrate can be hydrated and/or boiled for different minutes prior to their combination or mixing.

In another particular embodiment of the process, the water content of the sterilized cereal and optionally legume-containing substrate is from 40 to 85%, more particularly from 50 to 75% w/w.

In another particular embodiment of the process, for the preparation of the inoculum of step 1) the mixture of sterilized substrate comprising cereals, and optionally legumes, and the filamentous fungal culture are incubated for a time period from 1 to 30 days, more particularly for at least 1 week, even more particularly from 7 to 30 days, until the formation of hyphae and the mycelium network is developed. Typically, this can be observed when the mass looks completely white due to the mycelium colonization.

In another embodiment of the process, the fermentation of step i1) is carried out at a temperature from 21° C. to 28° C.

In another particular embodiment of the process, the sterilized isosmotic liquid composition used in step (i) for preparing a sterilized liquified inoculum, comprises sterilized water, glycerin between 20 and 50% (w/w) and CIK (potassium chloride) from 0.1 to 2 g/L. The production of the liquified inoculum consist in the fermentation of a solid substrate consisting in vegetable matter, including cereals, such as cereal grains, optionally legumes or any other plant derivative. After sterilization in autoclave this substrate is inoculated with the desired strain. After growing between 1 and 30 days depending on the strain, the inoculum is liquified in the sterilized medium with glycerin and CIK indicated above, 1-200 g/Kg, in a sterile mixer. After 10 to 30 s of mixing, the mixture is filtered in a sieve or mesh of filter allowing particles below 0.25 mm to pass through. The filtered liquid is used to inoculate the solid substrate through a spray, drops or pipetting or any other method of inoculation in sterility.

In another particular embodiment of the process, the sterilized isosmotic liquid composition used in step (i) has an osmolality from 0.5 to 3 Osm.

In another particular embodiment of the process, the isosmotic liquid composition is added to the fermented substrate in (1) in an amount from 1 to 200 g, more particularly from 5 to 50 g, per Kg of the fermented substrate.

In another particular embodiment of the process, the fermented substrate is liquified by homogenizing for a time period from 15 to 350 s, more particularly from 30 to 60 s.

In another particular embodiment of the process, the liquified fermented substrate is filtered in a sieve or mesh of filter allowing particles of a particle size equal to or lower than 0.25 mm to pass through.

In another particular embodiment of the process, the hydrating of the substrate in step (ii) is carried out with an aqueous composition, such a water or salted water at room temperature (i.e., 18-28° C.) and/or by hydrating while raising the temperature of said water or aqueous composition from 70° C. to 100° C. In the particular case when temperature is raised, the fermentable substrate is hydrated by boiling it for a period of time. Particular hydrating or boiling times are from 4 to 15 minutes, in particular selected from 4, 5, 6, 7, 8, 9 and 10 minutes. Different cereals and/or legumes in the substrate can be hydrated and/or boiled for different minutes prior to their combination or mixing for the further sterilization in the container permeable to gases.

Therefore, the substrate comprising one or more cereals and one or more legumes or a textured isolated protein thereof, is prepared by any of: (a) first combining the ingredients and then hydrating the mixture; or (b) first hydrating each of the ingredients and then mixing the hydrated ones.

In another particular embodiment of the process, the water content of the fermentable substrate is from 40 to 85%, more particularly from 50 to 75% w/w.

In another particular embodiment of the process, the step (iii) is carried out by inoculating in sterile conditions the sterilized fermentable substrate of step (ii) with the liquified inoculum of (i) in a v/w ratio of inoculum/substrate of 0.5-3.0 ml of inoculum per 100 g of sterilized fermentable substrate.

In another particular embodiment of the process, step (iv) is carried out for a time from 1 to 30 days, more particularly from 3 to 10 days, which is the time usually needed to allow the growth of hyphae and formation of a mycelial network within the fermented substrate to obtain the protein myceliated composition.

By means of this process, the inoculated filamentous fungus grows by developing the hyphae that will finally give the thread-like network called mycelium. The mycelium will form a network within the substrate and around the external substrate area, providing a cultured (i.e., fermented) substrate with the intact mycelial matrix. The skilled person in the art will understand that due to the final aim of the process (i.e., to obtain an edible myceliated composition) the inoculated filamentous fungi are edible, non-toxic fungi. Inventors have assayed with several species, all of them pertaining to the group of lignocellulolytic fungi. Thus, in a particular embodiment of the process of the invention, the filamentous fungal culture is from a filamentous lignocellulolytic fungus. Lignocellulolytic fungi are fungi that produce lignolytic enzymes and, thus, they can process (i.e., digest, degrade, etc.) lignocellulosic material. They belong to the class of fungi called agaricomycetes.

The inventors have also found that when the substrate of any of the steps (i) or (ii) contains oat, a faster mycelial growth takes place and the final texture of the myceliated composition highly resembles a patty of meat due to the presence of still non-decomposed oat grains.

Thus, it is really an optimal that in step (i) the sterilized cereal substrate comprises oat; and/or in step (ii) the sterilized fermentable substrate comprises oat, and in a most particular embodiment, that the sterilized substrate comprises oat and rice (i.e., flour or grains).

According to a particular embodiment, the sterilized cereal and optionally legume-containing substrate used in step (i) and the fermentable substrate of step (ii) are the same.

In also another particular embodiment of the process, the filamentous fungal culture is selected from the group consisting of edible ascomycetes and basidiomycetes, preferably a culture of fungi species of genera Pleurotus, Oudemansiella and Ganoderma.

Combinations of one or more species of these genera are also useful in a particular embodiment of the invention, as well as combinations of species of the same genera.

In a more particular embodiment, the filamentous fungal culture is of one or more species of Pleurotus selected from Pleurotus ostreatus and Pleurotus djamor.

In also another more particular embodiment, the filamentous fungal culture is of one or more species of Oudemansiella species. In particular, it is of Oudemansiella canarii.

Of interest is the use of filamentous lignocellulolytic fungi species that produce normal hyphae but also pseudoparechymal cells. The pseudoparenchyma is a tissue that superficially resembles plant parenchyma but is made up of an interwoven mass of hyphae. Examples of pseudoparenchymatous structures can be find in certain fungal structures such as ectomycorrhizal tips, sclerotia or cuticles of certain fruiting bodies.

In also another more particular embodiment, the filamentous fungal culture is of one or more species of Lentinula. In a more particular embodiment, the fungal culture is of Lentinula edodes.

In also another more particular embodiment, the filamentous fungal culture is of one or more species of Ganoderma.

Although the process of the first aspect may be carried out with all types of cereals and legumes, meanwhile oat is present in the fermentation steps (i), or oat and rice is present in the fermentation step (ii), in a more particular embodiment the fermentable substrate additionally comprises one or more cereals selected from the group consisting of corn, barley, rape grain, millet, and rye; and one or more legumes selected from soy, cheek bean, bean, and vetch, or a textured isolated protein thereof. The addition of one or more of these cereals or legumes imparts to the final product certain nutritive or organoleptic features without compromising the texture of the same. Versatility of fungi is maintained due to the presence of oat in the fermentation steps.

In a particular embodiment of the process, the fermentable substrate comprises other grains such as fruits from plants of the Brassicaceae or the Chenopodiaceae family, such as for example quinoa and rape grain. In a particular embodiment of the process, the fermentable substrate comprising one or more cereals including oat and rice, comprises oat, more particularly oat grains. More particularly, the grains have a particle size from 1 to 5 mm.

In another particular embodiment of the process, the fermentable substrate comprising one or more cereals including oat and rice, comprises oat, more particularly oat grains, and at least another cereal or other grain. More particularly, the cereals and/or the other grains have a particle size from 1 to 5 mm.

In another particular embodiment of the process, the fermentable substrate comprising one or more cereals including oat and rice, comprises oat and rice, more particularly oat and rice grains. More particularly, the grains have a particle size from 1 to 5 mm.

In another particular embodiment of the process, the fermentable substrate comprising one or more cereals including oat and rice, comprises oat and further comprises quinoa, more particularly oat and quinoa grains. More particularly, the grains have a particle size from 1 to 5 mm.

In yet another particular embodiment of the process, and especially when the edible myceliated composition is to be one with high protein contents, the sterilized fermentable substrate, comprises soy. In a more particular embodiment, the sterilized substrate comprises textured soy protein.

In another particular embodiment of the process, the fermentable substrate comprising one or more legumes or a textured isolated protein thereof comprises soy, more particularly textured soy protein, and chickpea.

In another particular embodiment, the fermentable substrate comprising cereals and legumes also comprises seeds of plants. More in particular, sunflower seeds.

As will be illustrated in the examples, a particular substrate has been found as highly appropriate for the growing of several fungi species, at the same time the final protein myceliated composition has meat-like features. Thus, in another particular embodiment of the process, the fermentable substrate comprising one or more cereals and one or more legumes or a textured isolated protein thereof, is one comprising oat (grains or flour), rice (grains or flour) and texturized soy protein. In even a more particular embodiment, the fermentable substrate is one that comprises oat grains, rice grains and texturized soy protein.

In another particular embodiment, the substrate comprises from 10% to 50% w/w of oat grains or flour. Thus, the percentage by weight of oat in the substrate in relation to the total weight of the substrate is selected from 10%, 20%, 30%, 40% and 50%.

In also another particular embodiment, the substrate comprises from 10% to 50% w/w of rice grains or flour. Thus, the percentage by weight of rice in the substrate in relation to the total weight of the substrate is selected from 10%, 20%, 30%, 40% and 50%.

In another particular embodiment, the substrate comprises from 10% to 50% c w/w of quinoa grains or flour. Thus, the percentage by weight of quinoa in the substrate in relation to the total weight of the substrate is selected from 10%, 20%, 30%, 40% and 50%.

In a yet also another particular embodiment, the substrate comprises from 30% to 50% w/w of textured soy protein, more in particular texturized soy in relation to the total weight of the substrate.

In a yet also another particular embodiment, the substrate comprises from 10% to 50% w/w of chickpea, in relation to the total weight of the substrate.

In even a more particular embodiment, the said substrate comprises 30% w/w of oat grains, 30% w/w of rice grains and 40% w/w of texturized soy protein. In another particular embodiment, the substrate comprises 10% w/w of oat grains, 50% w/w of rice grains and 40% w/w of texturized soy protein. In another also particular embodiment, the substrate comprises 50% w/w of oat grains, 10% w/w of rice grains and 40% w/w of texturized soy protein. In another also particular embodiment, the substrate comprises 10% w/w of oat grains, 20% w/w of quinoa grains, 20% of chickpea, and 50% w/w of texturized soy protein.

In another also particular embodiment of the process of the invention, the same includes a step of adding one or more aromatizing compounds, flavour compounds, lipids, colourants, oligoelements, vitamins, mineral salts, and combinations thereof. These additional compounds can be part of the fermentable substrate if they are not damaged or decomposed when due to the sterilization step. In an alternative, they can be added after step (iv) or during the same step (iv).

The addition of aromatizing and flavour compounds is advisable in case depending on the used fungi and substrate undesirable aromas or flavours remain in the composition.

In another particular embodiment of the process of the first aspect, optionally in combination with any of the embodiments of the process disclosed above or below, the step (iii) of culturing is carried out at a temperature from 21° C. to 28° C. Indeed, this step of culturing is carried out at the optimal conditions promoting the growing of mycelium and, in any case, under sterile conditions as previously commented.

The process of the invention can be carried out, for example, in a sterilized room or in a chamber in which the temperature, humidity and the air flow assures no contamination of the compositions with bacteria or other fungi, for example. As indicated, the working with the modular mode (in separated containers permeable to gases) facilitates the maintenance of sterile conditions. This is a challenging situation, since the sterility of the gases entering a chamber where the containers are disposed has also to be maintained, and when certain flow is required the options of contaminations are increased.

However, and advantageously, meanwhile the inoculation step is performed under sterile conditions, the incubation step can be done in a room with no sterility conditions if the sterilized substrate is first prepared and inoculated with the mycelium in a container allowing only gas permeability. Containers permeable to gases are those allowing gas diffusion (exchange), in order to provide oxygen to the fungi and to allow the elimination of CO₂. In other words, if the incubation is carried out in a recipient that avoids contamination of the substrate by the microorganisms that could be in the air of the incubation chamber, the process of the invention is moreover implementable in any room.

Inventors have also developed particular containers permeable to gases. In a particular embodiment of these containers, they comprise a base or dish and a cover or lid, said lid being slightly wider than the disk (i.e., like Petri dishes commonly used in microbiology laboratories). So that, being the perimetral contour (circular or not) of the lid higher than the corresponding perimetral contour of the base or dish, gases can pass through but any microorganism that could be in the air in chamber where incubation is done cannot enter into contact with the substrate being incubated.

The dishes are often covered with a shallow transparent lid, resembling a slightly wider version of the dish itself. The lids of glass dishes are usually loose-fitting.

With the performance of the method of the first aspect, an edible myceliated composition comprising mycelia of a filamentous fungus and a mixture of one or more fermented cereals and one or more fermented legumes is obtained.

In a particular embodiment, the edible myceliated composition comprising mycelia of a filamentous fungus and a mixture of one or more fermented cereals and one or more fermented legumes is obtainable by:
(0) preparing a sterilized liquified inoculum of a filamentous fungal culture (i.e., of a mycelium forming fungus) by: (1) adding under sterile conditions to a sterilized cereal and optionally legume-containing substrate, said substrate comprising at least oat, an amount of the filamentous fungal culture, and let the mixture ferment until the substrate is colonized with hyphae forming a mycelium network to obtain a fermented substrate; and (2) adding a sterilized isosmotic liquid to the fermented substrate in (1), and liquefying by mixing or homogenizing the mixture to obtain the sterilized liquified inoculum;
(ii) preparing a sterilized fermentable substrate, comprising one or more cereals, including oat and rice, and one or more legumes or a textured isolated protein of these legumes, by hydrating the substrate and disposing it in a container adapted to allow exchange of gases, and sterilizing the container with the substrate;
(iii) inoculating in sterile conditions the sterilized fermentable substrate of step (ii) with the liquified inoculum of (i); and
(iv) culturing the sterilized fermentable substrate with the liquified inoculum for a time to allow the growth of hyphae and formation of a mycelial network within the fermented substrate to obtain the myceliated composition, which is, in particular, an edible myceliated composition (i.e., a myceliated high protein food composition); wherein the fermented substrate comprises oat.

Throughout the description and claims the word “comprise” and variations of the word, are not intended to exclude other technical features, additives, components, or steps. Furthermore, the word “comprise” encompasses the case of “consisting of”. Additional objects, advantages and features of the invention will become apparent to those skilled in the art upon examination of the description or may be learned by practice of the invention. The following examples are provided by way of illustration, and they are not intended to be limiting of the present invention. Furthermore, the present invention covers all possible combinations of particular and preferred embodiments described herein.

### EXAMPLES

### Example 1. Preparation of a Meat Analogue

### Basic Lab Protocol

It is herewith disclosed the edible biomass production by means of the agglomeration and nutritional modification of an edible cereal and legume containing substrate carried out with filamentous fungi (ascomycetes and basidiomycetes).

Preparation of the fungal strains: For the preparation of the strains used in the experiments any one of the following were adequate, all of them being commercially available strains of Pleurotus ostreatus, Pleurotus djamor, Lentinula edodes, Ganoderma spp (i.e., Ganoderma applanatum, Ganoderma lucidum, Ganoderma resinaceum). All these species are lignocellulolytic fungi that form filamentous structures, as indicated.

Examples of commercially available strains of Pleurotus ostreatus: HK 35 (Sylvan, USA), 3253 (Sylvan, USA), 3115 (Sylvan, USA), 3009 (Sylvan, USA), M2175 (Mycelia, Belgium), 3015 (Amycel, the Netherlands).

Examples of commercially available Lentinula edodes: M3790 (Mycelia, Belgium), M3770 (Mycelia, Belgium), M3102 (Mycelia, Belgium), 4082 (Amycel, The Netherlands).

Examples of commercially available Pleurotus djamour: M2708 (Mycelia, Belgium)

Examples of commercially available Ganoderma applanatum: M9710 (Mycelia, Belgium)

Examples of commercially available Ganoderma lucidum: M9720 (Mycelia, Belgium), M9726 (Mycelia, Belgium)

Examples of commercially available Ganoderma resinaceum: M9732 (Mycelia, Belgium)

The strains were maintained in an agar mat extract medium (MEA, 12.7 g/L of malt extract, 10 g/L of glucose and 3 g/L of agar). Cultures were maintained in the darkness at 24° C. for 7 days.

### Preparation of the Substrates:

Hydrating by boiling (Cooking): Rice and oat grains were individually boiled to get the “al dente” cooked state (10-15 min). The water was decanted.

Hydrating: Textured soy protein chunks were hydrated at room temperature (i.e., 20-25° C.) considering the hydrating factor (2.5 w/w) for using the appropriate water amount. Water was added while mixing until no free water was observed. Once water was absorbed, the mixture was allowed to rest to improve diffusion all through the soy chunks.

### Preparation of Containers:

Once cooked or hydrated, the substrates were added to containers permeable to gases (i.e., fermenters), particularly prepared as disclosed below. The containers contained a homogeneous mixture with 30% w/w of cooked rice, 30% w/w of cooked oat and 40% w/w of the hydrated soy. Each container contained about 85 g of the mixture.

Sterilization: Sterilization of modular containers (i.e., stackable containers) and of recipients for preparing the inoculum was done in autoclave at 121° C. for 30 minutes.

Production of inoculum: The strains grown in MEA were inoculated to the recipients with the boiled oat. The recipients for the preparation of the inoculum contained 35 g of the cooked (i.e., boiled) oat. Culture was incubated at 24° C. for 1 week. After that, a suspension of the inoculum was prepared by adding 200 ml of a sterilized isosmotic aqueous solution and mixing the culture with a mixer.

Inoculation of the containers permeable to gases: Modular containers (i.e., stackable containers) containing the substrate composed by rice, oat and texturized soy protein (total weigh about 85 g) were inoculated with 2 ml of the inoculum suspension. Homogeneous colonization was assured by inoculating all through the substrate.

Incubation: The containers were incubated at 24° C. under sterile conditions After 7-10 days all containers showed mycelial colonization. These compositions were edible meat-like compositions (similar to patty meat), and they were proper for vegetarian, vegan and also for celiac people. Once further cooked, such as baked, oven processed or fried, the meat-like compositions behaved as actual meat as will be depicted in next examples.

The compositions so obtained are versatile, in terms that different fungi species and strains can be used. This versatility allows the customization of the meat-analogue for particular people (i.e., sport practitioners, elder people, people suffering from feeding problems, such as anorexia, children, etc.). Of particular interest is that Pleurotus species could be used with good results in terms of texture, but also acceptance by the consumers (see Examples 2 and 3 below), contrary to what was predicted according to the prior art.

When the myceliated compositions obtained by this process were compared with a non-myceliated “plant-based” patty meat-analogues, the later had a meat flavour but the amount and type of proteins was lower than that of the compositions of the invention. Moreover, the texture of the non-myceliated plant-based was far away from the actual meat patties unless additives were added. On the contrary, the edible myceliated compositions of the invention were highly similar in texture to the actual meat patties, when measured in a texturometer with a mini-Kamer probe and without any need of additives or of polymeric compounds.

One additional advantage of the obtained products was that they were not ultra-processed products, as non-myceliated “plant-based” patties are. Thus, they were obtained in a reproducible and non-complex process.

In addition, they were free of cholesterol but full of those compounds of the fungi, such as antioxidant compounds, vitamins (i.e., D vitamin), immunomodulator compounds, hypocholesterinaemia promoting compounds, antiviral compounds, among others. Their caloric contents were low, too.

The containers for the modular production of the edible myceliated composition included were Petri-like plaques. Thus, they comprised a dish or base, like a cuvette with a platform and a wall, and a cover or lid, said lid with a surface area and perimetral contour higher than the surface area and perimetral contour of the said base.

This way the gases can flow during the fermentation process of the substrate, and it is difficult any microorganism can enter in the recipient.

### Example 2. Test of Different Strains of Fungi and Substrate Composition

In order to illustrate the versatility of the process of the invention, as well as the good properties of the edible myceliated compositions obtained by the same, in this example and following the scheme of Example 1, several substrates including oat and fungi were tested.

### Manufacturing 1:

Fermentable substrate included 40% of texturized soy, 30% of rice grains and 30% of oat grains. Soy was hydrated as indicated in Example 1. Oat and rice grains were cooked (i.e., boiled) for 8-10 minutes separately and then mixed with the hydrated soy in several sterilized containers. Each of the substrates was inoculated with one fungal strain of each species (2 ml of inoculum prepared as in Example 1 per 85 g of substrate). The specie was Pleurotus ostreatus (commercially available strains HK 35 (Sylvan, USA) and 3253 (Sylvan, USA)). Incubation was carried out for 8 days at 25° C.

The resulting myceliated compositions were patty compositions resembling a meat-like burger according to their form.

They were cooked using oil in a pan (1-3 minute of cooking each side). The same protocol of cooking was performed with a meat patty (meat burger) and a non-myceliated plant-based patty were used as comparative examples for the sensorial and texture properties. The non-myceliated plant-based patty contained polymeric additives in its composition, as usual, to attain the cohesion of the components.

FIG. 1 shows a picture of a cooked edible myceliated composition (patty) of the invention. This picture allows seeing the non-homogeneity of the composition, in terms that it comprises a complex substrate (oat, rice and soy).

Sensorial test was carried out with volunteers and the taste of the patties obtained according to the process of the invention was neutral with an oat flavour with any of the tested fungi. The product was tasty although not previously salted. The aroma was pleasant, and the hamburger was compact texturized.

In a more in-depth analysis of the texture, the edible compositions of the invention and the meat and non-myceliated plant-based hamburgers were analysed by means of the texturometer TA-XT2PlusC (StableMicro Systems) with the mini-Kramer cell probe (HDP/MK05), as usually done for the characterization of multi-particle products or non-uniform products. To each sample a combination of compressive forces, cut forces and extrusion forces were simultaneously applied. The amount of each sample introduced in the texturometer was about 5.20 cm3, which is the amount people introduce in their mouths for oral chewing.

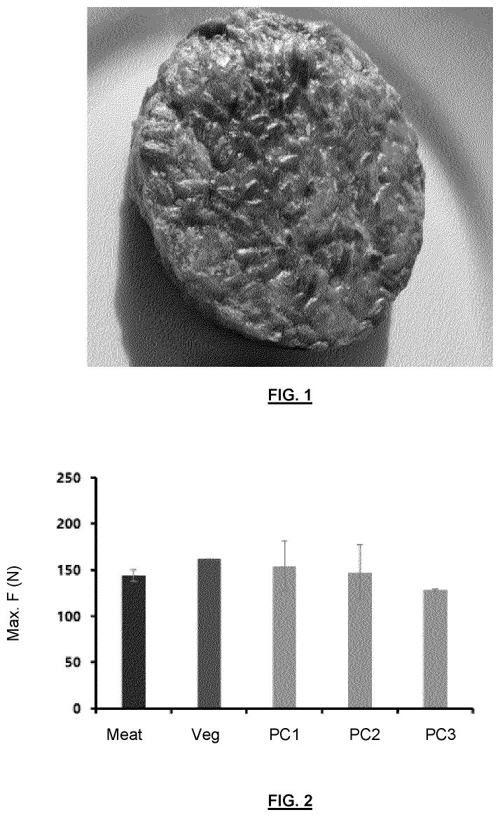

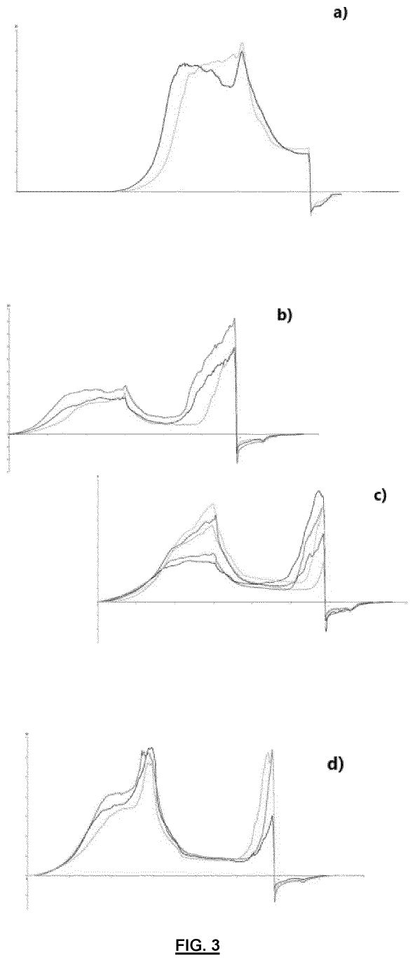

In FIG. 2, a bar diagram shows the maximal force obtained in the Kramer assay for each of the samples obtained with Pleurotus ostreatus, and in FIG. 3 ((a) to (d)) there are depicted the curves of force-distance derived from the Kramer analysis.

As can be seen from these figures, the texture of the myceliated compositions were in the order of the meat hamburger (i.e., maximal force (N) around 150). No significant differences were observed (p>0.05). The notation PC1, PC2 and PC3 corresponds to cooked patties with different amounts of oil in pan and different cooking times, namely 140 g of oil and 6 min of cooking for PC1; 140 g of oil and 4 min of cooking for PC2; and 50 g of oil and 4 min of cooking for PC3. The non-myceliated plant-based patty was the most different.

### Manufacturing 2:

Following the same scheme than in Manufacturing 1 section of this example, the following substrates and conditions were tested.

Fermentable substrate 1, 40% of texturized soy, 10% of rice grains and 50% of oat grains; Oat and rice grains were cooked (i.e., boiled) for 5 and 6 minutes, respectively and separately and then mixed with the hydrated soy (Example 1) in several sterilized containers. In an alternative operational oat and rice grains were cooked (i.e., boiled) for 10 and 8 minutes, respectively and separately.

Fermentable substrate 2, 40% of texturized soy, 50% of rice grains and 10% of oat grains; oat and rice grains were cooked (i.e., boiled) for 10 and 8 minutes, respectively and separately, and then mixed with the hydrated soy in several sterilized containers. In an alternative operational oat and rice grains were cooked (i.e., boiled) for 5 and 6 minutes, respectively and separately. Soy was hydrated as indicated in Example 1.

Each of the substrates was inoculated with one of the two strains of commercially available Pleurotus ostreatus (HK 35 (Sylvan, USA), 3253 (Sylvan, USA), 2 ml of inoculum prepared as in Example 1 per 85 g of substrate). Incubation was carried out for 12 days at 22° C. or 8-10 days at 27° C.

The resulting myceliated compositions were patty compositions resembling a meat-like burger according to their form.

They were cooked using oil and in similar conditions as in Manufacturing 1. Results of the texture analysis (not showed) gave maximal forces around 150 N as in meat hamburger in all cases. A slightly best sensorial test was obtained for the substrate 2 (50% rice) and when the boiling times were 5 and 6 minutes for oat and rice, respectively.

Inventors also tested the packaging options of the cooked edible myceliated compositions of the invention. Several packaging options, such as plastic wrapping and application of empty conditions were found very appropriate in terms of maintaining the features of the product (colour, flavour, aroma, etc.).

Although data not shown, equivalent and satisfactory results were obtained with Oudemansiella and Ganoderma species.

### Example 3. Edible Myceliated Compositions with a Fungal Strain (within Pleurotus Ostreatus) and a Fermentable Substrate Including 40% of Texturized Soy, 40% of Rice Grains and 20% of Oat Grains. Packaging and Microwave Cooking

For the preparation of a substrate comprising 40% of texturized soy, 40% of rice grains and 20% of oat grains, the rice and the oat was separately boiled for 6 and 10 minutes respectively.

The substrate was inoculated with one fungus specie (2 ml of inoculum prepared as in Example 1 per 85 g of substrate). The specie was Pleurotus ostreatus (commercially available strains HK 35 (Sylvan, USA), 3253 (Sylvan, USA)). Incubation was carried out for 8 days at 25° C.

The resulting myceliated compositions were patty compositions resembling a meat-like burger according to their form.

The myceliated compositions were then injected with oil and vacuum sealed with plastic. Without removing the plastic, the patties were autoclaved for 1 minute at 121° C. The same protocol was performed with a meat patty (meat burger) and a non-myceliated plant-based patty were used as comparative examples for the sensorial and texture properties. The non-myceliated plant-based patty contained polymeric additives in its composition, as usual, to attain the cohesion of the components.

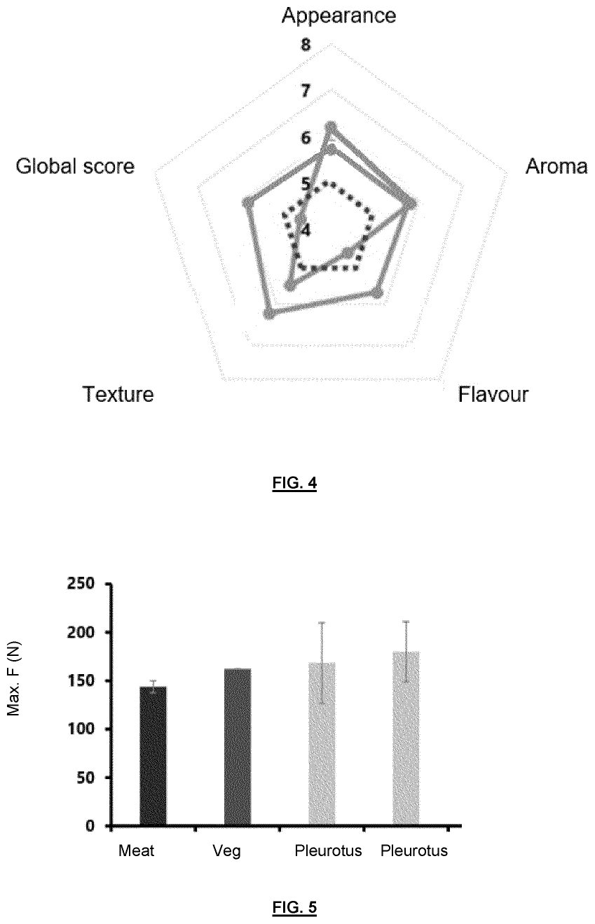

Sensorial test was carried out with volunteers and the taste of the patties obtained according to the process of the invention was neutral with an oat flavour with any of the tested fungi. The aroma was pleasant, and the hamburger was compact texturized. Good sensorial results were obtained according to volunteers, alleging very good values in terms of flavour, aroma, texture, appearance and global score. Sensorial data are depicted in FIG. 4, where a graphic shows the interconnections of all the analysed parameters for each of the batches (the two strains of P. ostreatus).

Finally, from the analysis of the texture using the texturometer TA-XT2PlusC (StableMicro Systems) with the mini-Kramer cell probe (HDP/MK05), as in the previous Examples and following the same parameters (i.e., amount of sample, compressive forces, etc.), it was concluded that with this substrate comprising 20% of oat grains, all the myceliated compositions were good meat-hamburger mimetics. Data are depicted in FIG. 5, were the maximal force obtained in the Kramer assay for each of the samples (Pleurotus ostreatus strains) are depicted in bars.

Although data not shown, equivalent and satisfactory results were obtained with Oudemansiella and Ganoderma species.

Data of the Examples 1 to 3 taken together allow affirming that edible compositions with high protein contents from the mycelium and the fermented substrate could be obtained with the process of the invention. Key aspects of the process are the double fermentation with several filamentous fungi producing mycelium, and the substrate comprising cereals and/or legumes in each of the fermentation steps (i.e., that of the preparation of the inoculum and that of the fermentation of the final substrate). The substrate comprising oat, rice and texturized soy gave good results with the tested fungi, thus supposing and actual versatile substrate that do not have the drawbacks of other substrates used in the prior art, mainly based on pea protein, which gives bad aromas and does not allow fungi versatility. In other words, the conversion rate with the selected substrate for the fermentations was adequate and many strains of one fungus species, as well as many different species, could ferment the substrate giving always satisfactory results.

These edible compositions of the invention behaved as a patty made of meat in terms of texture, and they were well scored in terms of flavour and aroma.

The data also demonstrate that with a non-complex but simplified method involving reduced times and operational methods, meat substitutes are achieved, which are even better than non-myceliated plant-based patties, for being highly nutritive without the need to add additives, as is usually the case in non-myceliated plant-based food for vegs and vegan people.

### Plackett Burman Assay

A Plackett Burman assay (Plackett-Burman randomised incomplete factorial) was performed to evaluate the importance of different ingredients in the substrate compositions for mycelium development (mycelium growth was the output response).

In this assay, the growth of Pleurotus ostreatus on different substrates was evaluated. For this purpose, edible grain meals (substrates) were prepared from oat (A), barley (B), soy protein (C), rapeseed (D), chickpea I, maize (F), millet (G), beans (H), pea (I), rye (J), sunflower seed (K) and rice (L). To evaluate which components showed significant effects on the growth of P. ostreatus, a Plackett Burman experimental design was carried out using the dry weight of the substrates as a factor with values of High: 0.3 g and Low: 0.1 g. The substrates were prepared individually in petri dishes of 10 cm diameter and 2 cm high, then hydrated to 80% humidity. The plates were wrapped in paper and autoclaved at 121° C. for 30 min. Once the substrates were cooled, the plates were inoculated with 6 mm diameter discs of P. ostreatus colonies in exponential growth phase. The cultures were incubated at 24° C. in the dark and after 5 days the growth rate of the colonies was measured.

The Placket Burman experimental design is represented in the following table, which the amounts in grams of the different components used during the trial.

| | Amount of components (g) | | | | | | | | | | | |
|---|---|---|---|---|---|---|---|---|---|---|---|---|
| Run | A | B | C | D | E | F | G | H | I | J | K | L |
| 1 | 0.3 | 0.3 | 0.1 | 0.3 | 0.3 | 0.3 | 0.1 | 0.1 | 0.1 | 0.3 | 0.1 | 0.3 |
| 2 | 0.3 | 0.1 | 0.3 | 0.3 | 0.3 | 0.1 | 0.1 | 0.1 | 0.3 | 0.1 | 0.3 | 0.3 |
| 3 | 0.1 | 0.3 | 0.3 | 0.3 | 0.1 | 0.1 | 0.1 | 0.3 | 0.1 | 0.3 | 0.3 | 0.3 |
| 4 | 0.3 | 0.3 | 0.3 | 0.1 | 0.1 | 0.1 | 0.3 | 0.1 | 0.3 | 0.3 | 0.1 | 0.3 |
| 5 | 0.3 | 0.3 | 0.1 | 0.1 | 0.1 | 0.3 | 0.1 | 0.3 | 0.3 | 0.1 | 0.3 | 0.3 |
| 6 | 0.3 | 0.1 | 0.1 | 0.1 | 0.3 | 0.1 | 0.3 | 0.3 | 0.1 | 0.3 | 0.3 | 0.3 |
| 7 | 0.1 | 0.1 | 0.1 | 0.3 | 0.1 | 0.3 | 0.3 | 0.1 | 0.3 | 0.3 | 0.3 | 0.3 |
| 8 | 0.1 | 0.1 | 0.3 | 0.1 | 0.3 | 0.3 | 0.1 | 0.3 | 0.3 | 0.3 | 0.1 | 0.3 |
| 9 | 0.1 | 0.3 | 0.1 | 0.3 | 0.3 | 0.1 | 0.3 | 0.3 | 0.3 | 0.1 | 0.1 | 0.3 |
| 10 | 0.3 | 0.1 | 0.3 | 0.3 | 0.1 | 0.3 | 0.3 | 0.3 | 0.1 | 0.1 | 0.1 | 0.3 |
| 11 | 0.1 | 0.3 | 0.3 | 0.1 | 0.3 | 0.3 | 0.3 | 0.1 | 0.1 | 0.1 | 0.3 | 0.3 |
| 12 | 0.1 | 0.1 | 0.1 | 0.1 | 0.1 | 0.1 | 0.1 | 0.1 | 0.1 | 0.1 | 0.1 | 0.3 |
| 13 | 0.1 | 0.1 | 0.3 | 0.1 | 0.1 | 0.1 | 0.3 | 0.3 | 0.3 | 0.1 | 0.3 | 0.1 |
| 14 | 0.1 | 0.3 | 0.1 | 0.1 | 0.1 | 0.3 | 0.3 | 0.3 | 0.1 | 0.3 | 0.1 | 0.1 |
| 15 | 0.3 | 0.1 | 0.1 | 0.1 | 0.3 | 0.3 | 0.3 | 0.1 | 0.3 | 0.1 | 0.1 | 0.1 |
| 16 | 0.1 | 0.1 | 0.1 | 0.3 | 0.3 | 0.3 | 0.1 | 0.3 | 0.1 | 0.1 | 0.3 | 0.1 |
| 17 | 0.1 | 0.1 | 0.3 | 0.3 | 0.3 | 0.1 | 0.3 | 0.1 | 0.1 | 0.3 | 0.1 | 0.1 |
| 18 | 0.1 | 0.3 | 0.3 | 0.3 | 0.1 | 0.3 | 0.1 | 0.1 | 0.3 | 0.1 | 0.1 | 0.1 |
| 19 | 0.3 | 0.3 | 0.3 | 0.1 | 0.3 | 0.1 | 0.1 | 0.3 | 0.1 | 0.1 | 0.1 | 0.1 |
| 20 | 0.3 | 0.3 | 0.1 | 0.3 | 0.1 | 0.1 | 0.3 | 0.1 | 0.1 | 0.1 | 0.3 | 0.1 |
| 21 | 0.3 | 0.1 | 0.3 | 0.1 | 0.1 | 0.3 | 0.1 | 0.1 | 0.1 | 0.3 | 0.3 | 0.1 |
| 22 | 0.1 | 0.3 | 0.1 | 0.1 | 0.3 | 0.1 | 0.1 | 0.1 | 0.3 | 0.3 | 0.3 | 0.1 |
| 23 | 0.3 | 0.1 | 0.1 | 0.3 | 0.1 | 0.1 | 0.1 | 0.3 | 0.3 | 0.3 | 0.1 | 0.1 |
| 24 | 0.3 | 0.3 | 0.3 | 0.3 | 0.3 | 0.3 | 0.3 | 0.3 | 0.3 | 0.3 | 0.3 | 0.1 |

The flour mixture formed a heterogeneous but well distributed matrix after sterilisation. The colonies were inoculated in the centre of the matrix and grew radially, homogeneously and mainly on the surface.

In the following table the crop growth radius in mm and standard deviation (SD) is shown.

| Sample | Radius | SD |
|---|---|---|
| 1 | 66.0 | 0.0 |
| 2 | 50.0 | 1.4 |
| 3 | 54.0 | 0.7 |
| 4 | 53.0 | 1.4 |
| 5 | 62.0 | 1.4 |
| 6 | 57.0 | 0.0 |
| 7 | 61.0 | 1.4 |
| 8 | 66.0 | 0.7 |
| 9 | 56.0 | 0.0 |
| 10 | 53.0 | 0.7 |
| 11 | 61.0 | 0.7 |
| 12 | 56.0 | 1.4 |
| 13 | 61.0 | 2.8 |
| 14 | 63.0 | 2.1 |
| 15 | 60.0 | 1.4 |
| 16 | 63.0 | 0.7 |
| 17 | 68.0 | 0.7 |
| 18 | 66.0 | 2.1 |
| 19 | 55.0 | 0.7 |
| 20 | 61.0 | 0.7 |
| 21 | 50.0 | 1.4 |
| 22 | 61.0 | 2.8 |
| 23 | 53.0 | 0.7 |
| 24 | 53.0 | 0.7 |

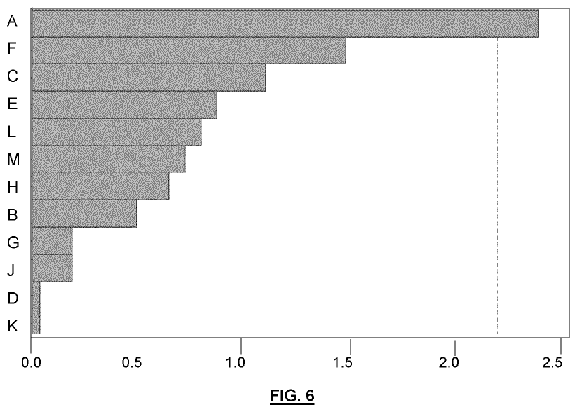

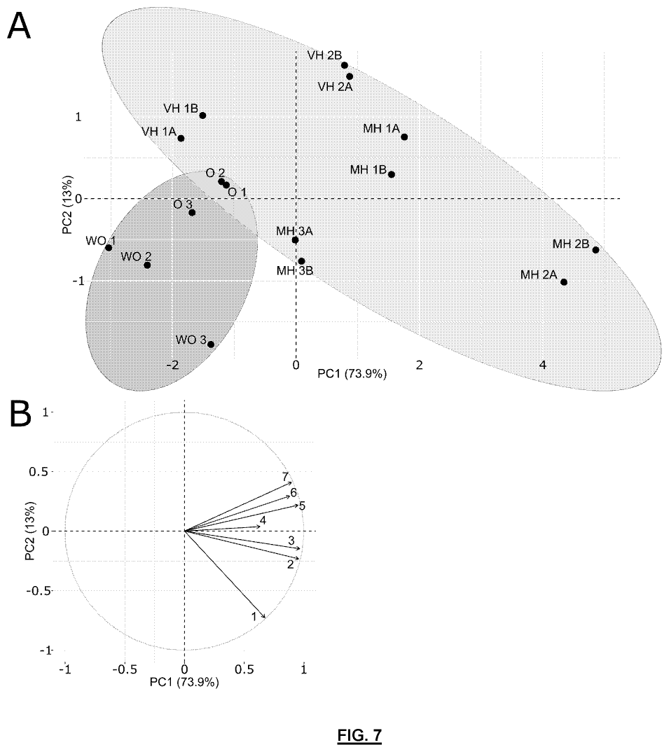

From the above values a Pareto chart was obtained (FIG. 6) which showed the individual standardized effect of each of the components of the substrate mixture on the growth of P. ostreatus (α=0.05). The discontinued line shows the significance level. As can be seen, oat (A) was the only component that showed a significant effect on the growth of P. ostreatus.

### Texture Analysis

A multivariate analysis of texture was carried out. The analysis compiles the data of many parameters involved in the texture measurement.

The results obtained in a principal component analysis (PCA) showed the texture values of fungi-based hamburgers with a selected combination of ingredients and of vegan and meat burgers currently on the market.

With regard to the tested fungi-based hamburgers, they were prepared by the process described in Example 1 using the same inoculum but a fermentable substrate having the composition showed in the following table:

| | Oat | | Quinoa | | Rye | | Chickpea | | Soy textured | Rape | |
|---|---|---|---|---|---|---|---|---|---|---|---|
| | ww % | mm | ww % | mm | ww % | mm | ww % | mm | protein (w/w %) | ww % | mm |
| O1 | 10 | 3 | 20 | — | 0 | — | 20 | 1 | 50 | 0 | — |
| O2 | 10 | 2 | 20 | — | 0 | — | 20 | 1 | 50 | 0 | — |
| O3 | 10 | 3 | 20 | — | 0 | — | 20 | 2 | 50 | 0 | — |
| WO1 | 0 | — | 25 | 1 | 25 | 1 | 25 | 1 | 0 | 25 | 1 |
| WO2 | 0 | — | 25 | 2 | 25 | 2 | 25 | 2 | 0 | 25 | 2 |
| WO3 | 0 | — | 25 | 3 | 25 | 3 | 25 | 3 | 0 | 25 | 3 |

FIG. 7 shows a score plot of the principal component analysis (PCA), showing how the different samples analysed are distributed in the first two principal components.

As can be seen, samples OA1, OA2 and OA3 are closer to the area of texture values for vegan and commercial meat patties considered “target”, while samples WOA1, WOA2 and WOA3 are further away. These results show that the use of oat as a fermentable substrate in the fermentation process improves the texture of the fermented products by mimicking the mechanical properties of meat.

### CITATION LIST

WO2020232347 (Mycotechnology Inc.)
WO2017181085 (Mycotechnology Inc.)
WO2020061502 (The Better Meat Company)

What is claimed is:

1. A process for the preparation of an edible myceliated composition comprising the following steps:
(i) Preparing a sterilized liquified inoculum of a filamentous fungal culture, preferably of a lignocellulolytic fungus by: (1) adding under sterile conditions to a sterilized cereal and optionally legume-containing substrate, said substrate comprising at least oat, an amount of the filamentous fungal culture, and let the mixture ferment until the substrate is colonized with hyphae forming a mycelium network to obtain a fermented substrate; (2) adding a sterilized isosmotic liquid to the fermented substrate in (1), and liquefying by homogenization the mixture of (2) to obtain the sterilized liquified inoculum;
(ii) Preparing a sterilized fermentable substrate, said substrate comprising one or more cereals including oat and rice, and one or more legumes or a textured isolated protein of these legumes, by hydrating the substrate and disposing it in a container adapted to allow exchange of gases, and sterilizing the container with the substrate;
(iii) Inoculating in sterile conditions the sterilized fermentable substrate of step (ii) with the liquified inoculum of (i); and
(iv) Culturing the sterilized fermentable substrate with the liquified inoculum for a time to allow the growth of hyphae and formation of a mycelial network within the fermented substrate to obtain an edible myceliated composition.

2. The process according to claim 1, wherein in step (i) the sterilized cereal and optionally legume-containing substrate comprises oat and rice.

3. The process according to claim 1, wherein the filamentous fungal culture is selected from the group consisting of edible ascomycetes and basidiomycetes, preferably a culture of fungi species of genera Pleurotus, Oudemansiella and Ganoderma.

4. The process according to claim 3, wherein the filamentous fungal culture is of one or more species of Pleurotus selected from Pleurotus ostreatus and Pleurotus djamor.

5. The process according to claim 3, wherein the filamentous fungal culture is of one or more species of Oudemansiella, in particular Oudemansiella canarii.

6. The process according to claim 1, wherein the fermentable substrate of step (ii), comprising one or more cereals and one or more legumes or a textured isolated protein thereof, comprises one or more cereals of corn, barley, rape grain, millet, and rye; and one or more legumes or a textured isolated protein thereof selected from soy, cheek bean, bean, and vetch.

7. The process according to claim 1, wherein the fermentable substrate of step (ii), comprises from 10% to 50% w/w of oat grains or flour.

8. The process according to claim 1, wherein the fermentable substrate of step (ii) comprises from 10% to 50% w/w of rice grains or flour.

9. The process according to claim 1, wherein the fermentable substrate of step (ii) comprises from 30% to 50% w/w of textured soy.

10. The process according to claim 1, wherein the fermentable substrate of step (ii), comprising one or more cereals and one or more legumes or a textured isolated protein thereof, comprises oat grains, rice grains and textured soy protein.

11. The process according to claim 10, wherein the fermentable substrate of step (ii), comprises from 20% to 30% w/w of oat grains, from 30% to 40% w/w of rice grains and from 30% to 40% w/w of textured soy protein, all combined percentages amounting to 100% of the substrate.

12. The process according to claim 1, wherein step (iii) of culturing is carried out at a temperature from 21° C. to 28° C.

13. A protein myceliated composition comprising mycelia of a filamentous fungus and a mixture of one or more fermented cereals and one or more fermented legumes, obtained by the method as defined in claim 1, wherein the fermented substrate comprises oat.

14. Use of a protein myceliated composition as defined in claim 13 as animal meat analogue.

15. An animal meat analogue comprising a protein myceliated composition as defined in claim 13.

16. The process according to claim 1, wherein in step (i) the sterilized cereal and optionally legume-containing substrate comprises oat and rice; and the filamentous fungal culture is selected from the group consisting of edible ascomycetes and basidiomycetes, preferably a culture of fungi species of genera Pleurotus, Oudemansiella and Ganoderma.

17. The process according to claim 16, wherein the fermentable substrate of step (ii), comprising one or more cereals and one or more legumes or a textured isolated protein thereof, comprises one or more cereals of corn, barley, rape grain, millet, and rye; and one or more legumes or a textured isolated protein thereof selected from soy, cheek bean, bean, and vetch.

18. The process according to claim 17, wherein the fermentable substrate of step (ii) comprises from 10% to 50% w/w of oat grains or flour; from 10% to 50% w/w of rice grains or flour; and from 30% to 50% w/w of textured soy, all combined percentages amounting to 100% of the substrate.

19. The process according to claim 18, wherein the fermentable substrate of step (ii), comprises from 20% to 30% w/w of oat grains, from 30% to 40% w/w of rice grains and from 30% to 40% w/w of textured soy protein, all combined percentages amounting to 100% of the substrate.

20. The process according to claim 19, wherein step (iii) of culturing is carried out at a temperature from 21° C. to 28° C.
